(19) United States
(12) Patent Application Publication
(10) Pub. No.: US 2006/0183549 A1
(43) Pub. Date: Aug. 17, 2006

(54) Codeword matching game using a mass media network

(76) Inventors: Timothy Yi-Chung Chow, Cambridge, MA (US); George Skaff Elias, Seattle, WA (US); Chenteh Kenneth Fan, Cambridge, MA (US); Richard Channing Garfield, Seattle, WA (US)

Correspondence Address: CHOATE, HALL & STEWART LLP, TWO INTERNATIONAL PLACE, BOSTON, MA, 02110, US

(21) Appl. No.: 11/059,781

(22) Filed: Feb. 17, 2005

(51) Int. Cl. G06F 19/00; G06F 17/00

(52) U.S. Cl. 463/42

(57) ABSTRACT

The home viewing audience of a program that is broadcast over a television or other mass media network plays a game by matching events on the program or its commercials with a personal telephone number or similar personal codeword. In one version, the organizers distribute a code table listing events that might occur on the program, and associate a code with each such event. A player watches for events listed on the code table, hoping to match the associated codes to parts of his codeword. A player becomes eligible to win if his entire codeword is successfully matched to codes of events that actually occur on the program, and may telephone a predetermined telephone number to declare his eligibility to win prizes. A second version of the game is like the first except there is no code table; the players watch for direct appearances of the codes themselves.

### FIELD OF THE INVENTION

The present invention relates to a method of playing a game with a program broadcast over a television network, or other mass media network, wherein the home audience has the potential to win prizes.

### BACKGROUND OF THE INVENTION

Television stations and networks face increasing challenges in their constant effort to attract and retain viewers. In recent years, the number of television channels has increased considerably, and hundreds of channels compete for the viewers' attention. Improved technology for allowing viewers to record broadcasts and skip over commercials during replay has begun to undermine the traditional business model whereby advertisers underwrite the costs of producing television programs in return for the privilege of periodically interrupting the broadcast to show their commercials.

To maintain viewer interest, the television industry has devised numerous genres of programming, including movies, soap operas, sitcoms, dramas, documentaries, sports events, cartoons, and others. Almost all of these programs rely entirely on their intrinsic entertainment value to hold the viewer's attention. One exception to this rule that has been tried on occasion is the idea of offering viewers, in the context of either a game show or a commercial, the opportunity to win prizes by playing a bingo-like or lottery-style game. The goal is to provide viewers with a financial incentive to pay close attention to a program or its commercials.

The major disadvantage of this idea, as implemented in the prior art, has been that game shows and commercials have a limited audience, and many people do not watch them. Specific embodiments in the prior art have suffered from other disadvantages as well. For example, it is often required that specialized hardware be obtained in advance in order to play the game. This creates a barrier to entry that discourages many from participating. In other cases, such as when a random phone number is broadcast and the lucky person with that particular phone number wins a prize, the viewer's role is completely passive, making the game uninteresting to play. In addition, this strategy fails to draw the viewers' attention to the actual content of a program and its commercials. Another disadvantage of most bingo-like, or lottery-style, games in the prior art is that they require players to pay to play. Such a requirement not only creates a barrier to entry, but also disqualifies some people who live where such activity is deemed to constitute illegal gambling.

Accordingly, there remains a need to provide a method of playing a game with any type of program, including but not limited to game shows, in order to increase interest in the program and its commercials by offering an incentive in the form of prizes. It would be desirable to provide a method of playing a game with the aforementioned characteristics wherein a minimum of advance preparation and specialized hardware is needed for a viewer to play and win. In addition, it would be desirable to provide a method of playing a game wherein viewers need not pay anything in order to play and win and the viewer is not merely a passive observer but has fun actively playing the game. Such a game would allow for a large number of players over a wide geographical area to play simultaneously.

### SUMMARY OF THE INVENTION

In accordance with the present invention, one or more programs scheduled to be broadcast over a television network or other mass media network are selected before the scheduled broadcast time in order to be used for playing a game. Any member of the audience is a potential player of the game. The organizers of the game specify a personal codeword for each player of the game. The codeword could be a personal identification number that the player already possesses, such as a telephone number or a social security number, or it might be a sequence of symbols computed from a personal identification number by using an algorithm. In certain embodiments, the codeword is a distinct, randomly generated sequence of symbols.

The organizers prepare a list of identifiable events that could potentially occur on a program or its commercials. These events could be events that occur naturally in the course of a program, or they could be specific events that the organizers deliberately insert into the broadcast. To each event on the list, the organizers associate a code, which is a sequence of symbols that potentially matches a fragment of a player's codeword.

Players follow the program during its scheduled broadcast time and look for the identifiable events. Each time such an event occurs on a program or its commercials, each player checks to see if the associated code matches part of his or her codeword. As the broadcast proceeds, more and more events occur, and players find more and more matches between their codewords and the codes associated to the occurring events. A player's eligibility to win is determined on the basis of his or her matches.

### DETAILED DESCRIPTION

The present invention relates to a game in which the players try to win by matching parts of a personal codeword with codes associated to specific events that occur during one or more programs broadcast over a mass media network. As used herein, the phrase “one or more programs” is used interchangeably with the phrase “a program”. In certain embodiments, a program is broadcast over a television network. In other embodiments, a program is a radio broadcast or is broadcast via internet “streaming”.

In one embodiment, the organizers select an all-new episode of a television sitcom that is scheduled to be broadcast some time in the future. In certain embodiments, the organizers specify that a player's telephone number is his or her codeword. The organizers create a list of identifiable events that might be shown on television during the broadcast or its commercial breaks. For example, the broadcast may be a television sitcom wherein John Superstar is a character on the sitcom. Three sample events might be, “a car commercial occurs during the first commercial break”, “John Superstar says ‘Let's get outta here!’”, and “John Superstar buys a new car.” The organizers create a code table by associating a code, such as a one- or two-digit numerical sequence, to each event on the list of identifiable events. For example, the codes for the three sample events could be “12”, “5” and “13”, respectively. The code table is made available to the viewer/players prior to said broadcast so that events may be associated with their respective codes during the playing of the game.

In certain embodiments, the code table is published and distributed to the audience. In other embodiments, the code table is obtained online and is optionally downloaded by the viewer/player. In still other embodiments, a viewer/player may subscribe to the game wherein said viewer/player obtains a code table on a regular and predetermined basis, such as weekly or monthly.

To play, a player obtains a code table and, as previously specified by the organizers, uses his or her codeword. In certain embodiments, the player's codeword is his or her telephone number. The player then watches the broadcast for events listed on the code table. Each time a listed event occurs, the player takes the code associated with that event on the code table and checks his or her codeword for an occurrence of that code. In certain embodiments, a code occurs in a codeword when the digits of that code appear consecutively and in the same order within the codeword. In other embodiments, if a code occurs multiple times in a codeword, the player may choose one of these occurrences, but only one. For example, using the sample events described above, if the player's codeword is “2025551234” and a car commercial occurs during the first commercial break, then the player finds that the associated code, “12”, does occur in his or her codeword. However, even if John Superstar buys a new car, the player does not find a match, because the code associated with this event, “13”, does not occur in his or her codeword. If John Superstar says “Let's get outta here!”, then the player will note three occurrences of the associated code “5” in his or her codeword, but he or she can use this code to match only one of the three occurrences. However, if John Superstar says “Let's get outta here!” again, then the player does get a second code of “5”, which he or she can use to match a second occurrence of “5” in his or her codeword.

The player continues watching for events and matching codes on the code table with parts of his or her codeword until every digit in his or her codeword is matched with some code corresponding to an event that has occurred. When this happens, the player contacts the game organizers to declare his or her eligibility to win the game. In certain embodiments, the player telephones a special number set up by the game organizers to declare his or her eligibility to win the game. In other embodiments, the player contacts the game organizers online or by mail. In still other embodiments, the player's codeword is his or her telephone number and the organizers utilize caller identification technology to identify players and verify their eligibility to win.

As described herein, in certain embodiments of the present invention the player's codeword is his or her telephone number. This aspect of the present invention eliminates the need for the distribution of the codeword and allows a player to play the game without the added steps of obtaining their codeword. Thus, a distinguishing feature of the game of the present invention is the ability to publicly broadcast the key to unlocking the player's codeword which the player already owns. In addition, when the player's codeword is his or her telephone number then the organizers can utilize caller identification technology to identify players and verify their eligibility to win.

The game organizers collect phone calls from players and select winners from among those who have called, or otherwise contacted the game organizers, according to some rule decided by the game organizers before the start of the game. For example, the winners might be the first ten people who have called in and have completely matched their codeword. Or in another game, the winners might be ten people selected at random from the first one thousand people who have called in and have completely matched their codeword.

In certain embodiments, the winners are awarded a prize which could take the form of merchandise, services or cash. Optionally, consolation prizes could be awarded to some or all of the players who have declared their eligibility to win but have not won.

A television program does not need to be a sitcom but could be any scheduled broadcast such as, but not limited to, a movie, a soap opera, a sitcom, a drama, a documentary, a sporting event, or a cartoon. In certain embodiments, the program is fiction, non-fiction, live, or prerecorded. In certain embodiments, the program is not readily available to players prior to its broadcast time. In other embodiments, the program is a rerun of a program previously broadcast. It will be appreciated that the identifiable events associated with a rerun program may be different than those associated for that same program during a prior broadcast.

In certain embodiments, the events on the list of identifiable events are chosen to heighten interest in a program. For example, a possible event could be “The President of the United States makes a guest appearance.” Players would then eagerly tune in to the program to see if this actually happens. Selection of interesting events is easier if the organizers preview a program when designing the code table. Accordingly, in another aspect of the present invention, the organizers preview a program when designing the code table. However, previewing is not necessary especially when a well-known character is involved in the broadcast. For example, if a program is an episode of a series that involves a well-known character called Phoebe who frequently talks about crystals, then the event “Phoebe mentions crystals” could be used without having prior knowledge of the contents of the episode. With respect to sports broadcasts, various events are likely to occur and are readily incorporated into the code table. For example, if a program is a live broadcast, such as a baseball game, events such as “a pitcher strikes out ten batters” could be used.

The following list gives further examples of identifiable events, that may occur during a particular television sitcom, together with an associated code, thus creating a “code table”.
0 Ross is the first main character to speak after the second commercial break.
0 First commercial break includes a fast food ad.
0 First commercial break includes a car ad.
1 Second commercial break includes a fast food ad.
1 Show begins in Monica's apartment.
1 Monica is the first main character to speak after the second commercial break.
2 Ross is the first main character to speak.
2 Second commercial break includes a soft drink ad.
2 First commercial break includes a soft drink ad.
3 Joey is the first main character to speak after the second commercial break.
3 Show begins in coffee house.
3 First commercial break includes a film ad.
4 Phoebe is the first main character to speak after the first commercial break.
4 Monica is the first main character to speak.
4 Rachel is the first main character to speak.
5 Second commercial break includes a car ad.
5 Chandler is the first main character to speak after the second commercial break.
5 Phoebe is the first main character to speak.
6 Second commercial break includes a film ad.
6 Rachel is the first main character to speak after the first commercial break.
6 Chandler is the first main character to speak.
7 Joey is the first main character to speak after the first commercial break.
7 Phoebe is the first main character to speak after the second commercial break.
7 First commercial break includes a bank ad.
8 Rachel is the first main character to speak after the second commercial break.
8 Chandler is the first main character to speak after the first commercial break.
8 Joey is the first main character to speak.
9 Second commercial break includes a bank ad.
9 ROSS is the first main character to speak after the first commercial break.
9 Monica is the first main character to speak after the first commercial break.
00 Ross and Phoebe are on a couch.
00 Phoebe takes a sip of something.
01 Monica is wearing boots.
02 Rachel is wearing a skirt.
03 Phoebe hugs someone.
04 Rachel is watching TV.
05 Monica is seen at work.
06 Ross shakes someone's hand.
07 Monica is talking on a telephone.
08 Chandler and Rachel are on a couch.
09 A woman Ross has dated but not married is seen.
10 Joey hits on a woman.
11 Chandler seen at work.
11 Joey and Monica are on a couch.
12 A main character gets a job.
13 Phoebe and Monica are on a couch.
14 Someone other than Joey says “How YOU doing?”
15 Ross kisses someone.
16 Joey hugs someone.
17 Chandler and Joey are on a couch.
18 The main characters are playing a game or a sport.
19 Joey kisses someone.
20 Phoebe says “Goddess”, or “Aura”, or “Crystal”.
21 Phoebe sings.
22 Chandler makes fun of Joey.
22 Phoebe and Rachel are on a couch.
23 Chandler does his sneer sarcastic silent laugh.
24 Chandler makes fun of Ross.
25 Phoebe is in Ross's or Joey's apartment.
26 Chandler makes fun of Ross.
27 Chandler has his legs crossed.
28 Phoebe says “Mother”.
29 Chandler makes fun of Ross.
30 Phoebe kisses someone.
31 One of Ross's ex-wives (other than Rachel) is seen.
32 Ross laughs sarcastically.
33 All six main characters are on screen, somewhere other than the coffee place or Monica's apartment.
33 Rachel is in pajamas or a nightgown.
34 Phoebe is wearing a shawl.
35 Ross and Monica are on a couch.
36 Monica is in pajamas or a nightgown.
37 Ross says a word six or more syllables long.
38 Monica hits someone.
39 Phoebe is wearing a scarf.
40 Ross says “Dinosaur” or “Dinosaurs”.
41 Gunter is seen after the second commercial break.
42 Gunter says something.
43 Joey opens a refrigerator.
44 Chandler makes fun of Monica.
44 A main character loses a job.
45 Joey and Rachel are on a couch.
46 Monica and Rachel are on a couch.
47 Rachel has both hands full.
48 Rachel is wearing boots.
49 Someone says “High school”.
50 Phoebe is wearing a necklace.
51 Rachel shakes someone's hand.
52 Chandler hugs someone.

One of ordinary skill in the art would recognize that numerous other code tables may be created from the same broadcast program using a variety of events associated with particular codes. Accordingly, another aspect of the present invention provides a code table comprising a listing of potential events, associated with a particular broadcast program, and a discrete code associated with each potential event.

A player's phone number is not the only possible codeword. The organizers may use some other personal identification number. For example, in alternate embodiments, a player's social security number is used. In fact, arbitrary sequences of symbols could be used as codewords.

The organizers may optionally use an algorithm to transform a personal identification number into a special sequence of symbols and use this sequence as a codeword. The algorithm could be distributed to all players along with the code table either via a printed publication or through the internet or some other mass distribution network. Alternatively, the organizers could simply arbitrarily assign codewords to players in such a way that every player has an equal probability of winning.

In accordance with the present invention, codes are sequences of one or more symbols that could potentially be found within a codeword. Optionally, one or more codes involve one or more instances of a wildcard symbol, which would represent any single symbol used in a codeword.

Various rules for matching codes to parts of a codeword are contemplated by the present invention. For example, the organizers could allow a match to occur when a code is found either forwards or backwards within a codeword. As another example, the organizers could allow codes to wrap around the end of a codeword; that is, if “ABC” is a codeword and the code is “CA”, then the player would have a match if the rules allow wrap-around. Both of the aforementioned modifications could simultaneously be adopted.

Another possible matching rule requires the players to arrange the symbols of their codewords into a grid pattern, and declare a match if a code can be found in a straight horizontal, vertical, or diagonal line within the grid.

When a player is matching more than one code, the codes might cover overlapping portions of the codeword. For example, if the codeword is “ABC” and the codes are “AB”, “BC” and “C”, then the only occurrences of “AB” and “BC” overlap whereas the only occurrences of “AB” and “C” do not. If two codes overlap, then the organizers can choose to allow both matches to count, or alternatively they could allow the player to use one or the other match, but not both.

If the organizers have control over the broadcast, then they may choose to help players identify when a code becomes available by broadcasting the code itself. For example, if an event associated with the code “12” occurs on a television sitcom, the code “12” could be made to pop up on the screen at the moment the event occurs.

In another embodiment of the invention, the code table is entirely dispensed with and instead codes are delivered by broadcasting the codes at select times during the program or any of its commercial breaks. One advantage of not utilizing the code table, is that it can be used with any program, including programs whose content is already known to viewers, such as reruns. In addition, the organizers' task is greatly simplified; the organizers no longer need to preview the program to find suitable events. The organizers also enjoy greater flexibility with respect to the timing of the appearance of codes. In this aspect of the invention, familiarity with the characters on the program is immaterial.

Yet another embodiment of the present invention utilizes a program expressly created to support the playing of this game by staging stunts whose outcomes are associated with specific codes. For example, a member of the studio audience might be brought on stage as a contestant. The contestant is given a dart and shown a large dartboard decorated with codes. The contestant, who may also be trying to match his or her own personal codeword, attempts to hit a code. Whatever code he or she happens to hit becomes available for matching to all players of the game. Another example stunt would be to have the contestant suggest two codes, one desirable and one undesirable. The contestant is then given a stunt; for example, he or she could be asked to complete an obstacle course within one minute. If he or she succeeds, his or her desired code becomes available for matching to all players of the game. If he or she fails, his or her undesired code becomes available for matching to all players of the game. As a third example, suppose that each of two contestants desires a code that the other does not. In this case, they could be made to compete for their preferred code to become available to all players of the game. For instance, they might race each other to see who can bob for more apples. One of ordinary skill in the art would recognize that numerous “stunts” are amenable to the game of the present invention. Accordingly, it will be appreciated that the above examples are not limiting.

To implement any of the above embodiments effectively, special-purpose hardware and/or software that collects and processes the large number of telephone calls that could potentially occur during the broadcast of the program can be used. For example, automatic call distribution coupled with computer telephony integration, as currently used in many large call centers, could be used. Such technology is well known to one of ordinary skill in the art.

In certain embodiments, the game is implemented using a program broadcast on mass media networks other than television, such as the internet, radio, or other wireless networks.

It will be appreciated that, in the event that a program is broadcast at different times in different time zones, the organizers can implement different versions for each separate broadcast time.

Players will probably have more fun playing the game if they feel that they retain a chance of winning all the way through a program. Accordingly, in another aspect of the present invention, not too many players are eliminated from contention early in a program, and a player is not be able to win until relatively late in a program. Moreover, it might be desirable for nearly all players to be very close to completely matching their codeword by the end of a program. Thus, according to yet another aspect of the present invention, the organizers adjust the choice of codes, the frequency of identifiable events, and the association of codes to these events.

Another aspect of the present invention provides a game, comprising a distinct codeword for each player, wherein said player matches a part of said codeword with a code, and wherein said code is associated with a specific event that occurs during one or more programs broadcast over a mass media network. In certain embodiments, said game comprises a code table which associates said code to an event that could potentially occur during a program. In other embodiments, said code is broadcast on q program or on a commercial advertisement. According to another aspect of the game, the player's codeword is his or her telephone number and is identified by caller identification technology.

Numerous alterations of the format and the playing of the game are possible. For example, rather than basing eligibility to win on completely matching a codeword, the organizers could declare that the players who have completely avoided any codeword matches during a program are the ones who are eligible to win. It is to be understood that the present disclosure relates to preferred embodiments of the invention which are for purposes of illustration only and are not to be considered as a limitation of the invention.

We claim:

1. A game comprising a distinct codeword for each player, wherein said player matches a part of said codeword with one or more codes, and wherein said code is associated with a specific event that occurs during either one of, or both of, a program or a commercial advertisement broadcast over a mass media network, wherein:
(a) said game comprises a code table which associates said code to an event that could potentially occur during said program; or
(b) said code is broadcast on said program or on a commercial advertisement.

2. The game according to claim 1, wherein said codeword is a telephone number, a social security number, or a sequence of symbols that is derived from a personal identification number.

3. The game according to claim 1, wherein said mass media network is a television network.

4. The game according to claim 3, wherein said codeword is a telephone number and is identified by caller identification technology.

5. The game according to claim 4, wherein said game comprises a code table and said code table is made available to the player prior to said broadcast.

6. A code table, for playing a game, comprising a listing of potential events associated with a particular program broadcast over a mass media network and a discrete code associated with each potential event.

7. The code table according to claim 6, wherein said code table is printed in a publication and is optionally available by subscription wherein a player obtains said code table on a regular and predetermined basis.

8. The code table according to claim 6, wherein said code table is obtained via the internet and is optionally downloaded.

9. A method of playing the game according to claim 1, wherein said game comprises a code table which associates said code to an event that could potentially occur during said program, said method comprising the steps of:
(a) selecting a program before its scheduled broadcast time, wherein said program is broadcast over a mass media network;
(b) obtaining a codeword comprising a plurality of symbols;
(c) obtaining the code table that associates a code to an event that could potentially occur during said program;
(d) following said program to find a match between a part of said codeword and a code that is associated to an event that actually occurs, wherein said code is found in said code table; and
(e) repeating step (d) until symbols of the codeword are matched with a code from said code table such that said matches satisfy a predetermined criterion for ending the game.

10. The method according to claim 9, wherein said mass media network is a television network.

11. The method according to claim 10, wherein said codeword is a telephone number, a social security number, or a sequence of symbols that is derived from a personal identification number.

12. The method according to claim 11, wherein said codeword is a telephone number and is identified by caller identification technology.

13. The method according to claim 10, wherein said program is fiction, non-fiction, live, or prerecorded.

14. A method of playing the game according to claim 1, wherein said code is broadcast on a program or on a commercial advertisement, comprising the steps of:
(a) selecting a program before its scheduled broadcast time, wherein said program is broadcast over a mass media network;
(b) obtaining a codeword comprising a plurality of symbols;
(c) following said program to find a match between a part of said codeword and a code that is associated to an event that actually occurs, wherein said code is broadcast on said program or on a commercial advertisement; and
(d) repeating step (c) until all symbols of the codeword are matched with a code such that said matches satisfy a predetermined criterion for ending the game.

15. The method according to claim 14, wherein said program is a game show designed to generate said code.

16. The method according to claim 14, wherein said codeword is a telephone number, a social security number, or a sequence of symbols that is derived from a personal identification number.

17. The method according to claim 14, wherein said mass media network is a television network.

18. The method according to claim 16, wherein said codeword is a telephone number and is identified by caller identification technology.

19. The method according to claim 9, further comprising the step of winning merchandise, a prize, or cash.

20. The method according to claim 14, further comprising the step of winning merchandise, a prize, or cash.
